(19) United States
(12) Patent Application Publication
(10) Pub. No.: US 2016/0354266 A1
(43) Pub. Date: Dec. 8, 2016

(54) BATHTUB LIFT ASSEMBLY

(71) Applicant: TINN-CO- INC., Saint-Augustin-de-Desmaures (CA)

(72) Inventors: Paulo OUELLET, Quebec (CA); Nicolas DUSSAULT, Saint-Raymond (CA)

(21) Appl. No.: 15/171,637

(22) Filed: Jun. 2, 2016

Related U.S. Application Data
(60) Provisional application No. 62/170,021, filed on Jun. 2, 2015.

(51) Int. Cl. A61G 7/10; A47K 3/12

(52) U.S. Cl. CPC A61G 7/1003; A47K 3/122; A61G 7/1015

(57) ABSTRACT

A bathtub lift assembly for a bathtub is provided. The bathtub lift assembly comprises: a bathtub frame, a lifting assembly including a vertically-extending lift post mounted to the bathtub frame and translatable between a raised configuration and at least one lowered configuration, a post actuator mounted to the bathtub frame, and a transmission assembly mounted to the bathtub frame and operatively connecting the post actuator and the vertically-extending lift post. The transmission assembly can include a ratio multiplier assembly. The bathtub lift assembly can also include a lift post rotation actuator operatively connected to the vertically-extending lift post and activable to configure the vertically-extending lift post between a loading configuration and a bathing configuration.

### CROSS-REFERENCE TO RELATED APPLICATION

This application claims priority under 35USC§119(e) of U.S. provisional patent application 62/170,021 filed on Jun. 2, 2015, the specification of which is hereby incorporated by reference.

### TECHNICAL FIELD

The present invention relates to reduced mobility assistance accessories. More particularly, it relates to a bathtub lift assembly for raising a seat from a position outside a bathtub, swinging the seat over a cavity of the bathtub, lowering the seat into the cavity of the bathtub, and performing the same in a reverse order.

### BACKGROUND

The use of bathtub lifts to assist persons with reduced mobility for transfer into and out of a bathtub is known. Typically, the vertical range of motion of the bathtub lift is limited, and thus the height of the bathtub side walls must be reduced accordingly such that the seat may clear the sidewalls when rotated from the position exterior to the bathtub to the position above the bathtub.

Furthermore, another drawback is that when the bathtub lift is being vertically moved, uncontrolled rotation of the post is possible, causing a safety issue to the person supported by the seat.

In view of the above, there is a need for an improved bathtub lift for a bathtub, which would be able to overcome or at least minimize some of the above-discussed concerns.

### SUMMARY

According to a general aspect, there is provided a bathtub lift assembly for a bathtub having a bathing cavity. The bathtub lift assembly comprises: a bathtub frame configured to at least partially surround the bathing cavity of the bathtub; a lifting assembly comprising a vertically-extending lift post mounted to the bathtub frame and translatable along a post axis between a raised configuration and at least one lowered configuration: a linear actuator mounted to the bathtub frame and translatable between an extended configuration and a retracted configuration along a linear actuator axis; and a transmission assembly mounted to the bathtub frame and comprising at least one belt or chain defining a closed-loop path with an actuator section extending along the linear actuator axis and a post section extending along the post axis. The vertically-extending lift post is engaged with the at least one belt or chain in the post section and the linear actuator is engaged with the at least one belt or chain in the actuator section. A translation of the linear actuator between the extended configuration and the retracted configuration drives the at least one belt or chain along the closed-loop path and the vertically-extending lift post between the raised configuration and the at least one lowered configuration.

In an embodiment, the bathtub frame comprises a longitudinally extending section and the linear actuator and the transmission assembly are mounted to the longitudinally extending section of the bathtub frame with the actuator section of the closed-loop path extending longitudinally along the longitudinally extending section of the bathtub frame and the post section of the closed loop path extending vertically along the longitudinally extending section of the bathtub frame.

In an embodiment the vertically-extending lift post comprises a tubular member having a substantially constant diameter from a lower end to an upper end thereof.

In an embodiment, the lifting assembly further comprises a collar bearing mounted to the bathtub frame and at least partially surrounding at least a section of the vertically-extending lift post to guide the vertically-extending lift post between the raised configuration and the at least one lowered configuration.

In an embodiment, a translation of the linear actuator between the extended configuration and the retracted configuration defines a linear actuator course and a translation of the vertically-extending lift post between the raised configuration and a lowest one of the at least one lowered configuration defines a longest post course, the longest post course being longer than the linear actuator course.

In an embodiment, the transmission assembly comprises a ratio multiplier assembly and the at least one belt or chain comprises a first belt or chain defining a first closed-loop path and a second belt or chain defining a second closed-loop path, the first belt or chain and the second belt or chain being engaged with the ratio multiplier assembly, the first belt or chain being driven in rotation around the first closed-loop path by the linear actuator, the second belt of chain being engaged in rotation around the second closed-loop path through the ratio multiplier assembly and engaging the vertically-extending lift post in translation.

In an embodiment, the lifting assembly further comprises a vertical guide assembly including a guiding rail mounted to the bathtub frame and extending substantially parallel to the vertically-extending lift post and a guide translatable with the vertically-extending lift post, the guiding rail and the guide being engageable together for preventing rotation of the vertically-extending lift post during the translation thereof and being disengageable from one another in the raised configuration to allow rotation of the vertically-extending lift post.

In an embodiment, the lifting assembly further comprises a seat support assembly extending from an upper section of the vertically-extending lift post.

According to another general aspect, there is provided a bathtub lift assembly for a bathtub having a bathing cavity. The bathtub lift assembly comprises: a bathtub frame configured to at least partially surround the bathing cavity of the bathtub; a lifting assembly including a vertically-extending lift post mounted to the bathtub frame and translatable along a post axis between a raised configuration and at least one lowered configuration; a lift post translation actuator mounted to the bathtub frame; and a transmission assembly mounted to the bathtub frame and comprising a ratio multiplier assembly and at least two belts or chains including an actuator belt or chain defining an actuator closed-loop path and a post belt or chain defining a post closed-loop path including a post section extending along the post axis. The vertically-extending lift post is engaged with the post belt or chain in the post section. The actuator belt or chain is driven by the lift post translation actuator. The actuator belt or chain and the post belt or chain are operatively connected to one another through the ratio multiplier assembly. The ratio multiplier assembly comprises an input gear or pulley secured to an output gear or pulley of a larger diameter, the input gear or pulley being engaged in rotation by the actuator belt or chain and the output gear or pulley driving the post belt or chain in rotation. Activation of the lift post translation actuator drives the actuator belt or chain and the post belt or chain respectively along the actuator closed-loop path and the post closed-loop path, and the vertically-extending lift post between the raised configuration and the at least one lowered configuration.

In an embodiment, the actuator belt or chain comprises a translation actuator section extending along an actuator axis, the lift post translation actuator being engaged with the actuator belt or chain in the translation actuator section; wherein the bathtub frame comprises a longitudinally extending section; and wherein the lift post translation actuator and the transmission assembly are mounted to the longitudinally extending section of the bathtub frame with the translation actuator section of the actuator belt or chain extending longitudinally along the longitudinally extending section of the bathtub frame and the post section of the post belt or chain extending vertically along the longitudinally extending section of the bathtub frame.

In an embodiment, the lift post translation actuator is a linear actuator and a translation of the linear actuator between an extended configuration and a retracted configuration defines a linear actuator course and a translation of the vertically-extending lift post between the raised configuration and a lowest one of the at least one lowered configuration defines a longest post course, the longest post course being longer than the linear actuator course.

In an embodiment, the vertically-extending lift post comprises a tubular member having a substantially constant diameter from a lower end to an upper end thereof.

In an embodiment, the lifting assembly further comprises a collar bearing mounted to the bathtub frame and at least partially surrounding at least a section of the vertically-extending lift post to guide the vertically-extending lift post between the raised configuration and the at least one lowered configuration.

In an embodiment, the lifting assembly further comprises a vertical guide assembly including a guiding rail mounted to the bathtub frame and extending substantially parallel to the vertically-extending lift post and a guide translatable with the vertically-extending lift post, the guiding rail and the guide being engageable together for preventing rotation of the vertically-extending lift post during a translation thereof and being disengageable from one another in the raised configuration to allow rotation of the vertically-extending lift post. The guide can further comprise at least one slider protruding from the vertically-extending lift post.

In an embodiment, the ratio multiplier assembly has a multiplier ratio of 0.5 to 1.

In an embodiment, the actuator belt or chain at least partially surrounds the input gear or pulley and the post belt or chain at least partially surrounds the output gear or pulley.

In an embodiment, the lifting assembly further comprises a seat support assembly extending from an upper section of the vertically-extending lift post.

According to a further general aspect, there is provided a bathtub lift assembly for a bathtub having a bathing cavity. The bathtub lift assembly comprises: a bathtub frame configured to at least partially surround the bathing cavity of the bathtub; a lifting assembly including a vertically-extending lift post mounted to the bathtub frame and translatable along a post axis between a raised configuration and at least one lowered configuration and rotatable about the post axis between a loading configuration and a bathing configuration; a lift post translation actuator mounted to the bathtub frame and operatively connected to the vertically-extending lift post and activable to translate the vertically-extending lift post between the raised configuration and the at least one lowered configuration; a lift post rotation actuator, translatable between an extended configuration and a retracted configuration, the lift post rotation actuator being mounted to the bathtub frame and activable to rotate the vertically-extending lift post between the bathing configuration and the loading configuration, wherein the lift post rotation actuator and the lift post translation actuator are activable one at a time; and a push-pull assembly. The push-pull assembly comprises a swivel assembly mounted to the bathtub frame and a post rod operatively connecting the vertically-extending lift post and to the swivel assembly. The swivel assembly includes a rotatable roller rotatable about a roller rotation axis, an actuator cam secured to the rotatable roller and engaged with the lift post rotation actuator at an eccentric attachment point with respect to the roller rotation axis, and a post cam secured to the rotatable roller and engaged with the post rod at an eccentric attachment point with respect to the roller rotation axis. Translation of the lift post rotation actuator engages the rotatable roller and the post cam in rotation through the actuator cam and rotation of the post cam displaces the post rod, and displacement of the post rod rotates the lift post between the loading configuration and the bathing configuration, when the vertically-extending lift post is configured in the raised configuration.

In an embodiment, the actuator cam and the post cam rotate simultaneously with the rotatable roller and are angularly offset.

In an embodiment, the lifting assembly further includes a rotation imparting assembly comprising a first connector mounted to the vertically-extending lift post and a second connector operatively connected to the lift post rotation actuator, displaceable by a change of configuration of the lift post rotation actuator, and engageable with the first connector in the raised configuration of the vertically-extending lift post, wherein, when the first connector and the second connector are engaged together, a displacement of the second connector imparts a rotation of the first connector and the vertically-extending lift post about the post axis. The lifting assembly further can comprise a post flange mounted to a lower section of the vertically-extending lift post and the first connector can comprise an aperture defined in the post flange, and the second connector can comprise a pin extending substantially parallel to the vertically-extending lift post, rotatable about the post axis, and engageable with the aperture defined in the flange when the vertically-extending lift post is in the raised configuration. The second connector can comprise a rotation actuator flange at least partially surrounding the post axis and being rotatable thereabout, the pin protruding from the rotation actuator flange, the second connector being operatively connected to the swivel assembly via the post rod wherein a change of configuration of the lift post rotation actuator imparts a rotation to the rotation actuator flange and the pin about the post axis through the swivel assembly and the post rod. The lifting assembly can further comprise a vertical guide assembly including a guiding rail mounted to the bathtub frame and extending substantially parallel to the vertically-extending lift post and the post flange can comprise at least one notch, the guiding rail being engageable with the at least one notch. The at least one notch can comprise a bathing configuration notch and a loading configuration notch, the bathing configuration and the loading configuration notches being angularly offset from one another, the guiding rail being selectively engaged with the bathing configuration notch for translating of the vertically-extending lift post in the bathing configuration and with the loading configuration notch for translating of the vertically-extending lift post in the loading configuration.

The lifting assembly further can comprise a vertical guide assembly including a guiding rail defining an elongated groove extending substantially parallel to the vertically-extending lift post and at least one slider protruding from one of the flange and vertically-extending lift post, the elongated groove being configured to slideably receive the at least one slider therein. The at least one slider can comprise a bathing configuration slider and a loading configuration slider, the bathing configuration and the loading configuration sliders being angularly offset from one another, the elongated groove selectively receiving the bathing configuration slider for translating of the vertically-extending lift post in the bathing configuration and with the loading configuration slider for translating of the vertically-extending lift post in the loading configuration.

In an embodiment, the lift post translation actuator is a linear actuator and a translation of the linear actuator between the extended configuration and the retracted configuration defines a linear actuator course and a translation of the vertically-extending lift post between the raised configuration and a lowest one of the at least one lowered configuration defines a longest post course, the longest post course being longer than the linear actuator course.

In an embodiment, the vertically-extending lift post comprises a tubular member having a substantially constant diameter from a lower end to an upper end thereof.

In an embodiment, the lifting assembly further comprises a collar bearing mounted to the bathtub frame and at least partially surrounding at least a section of the vertically-extending lift post to guide the vertically-extending lift post between the raised configuration and the at least one lowered configuration.

In an embodiment, the bathtub lift assembly further comprises a transmission assembly mounted to the bathtub frame and comprising a ratio multiplier assembly and at least two belts or chains including an actuator belt or chain defining an actuator closed-looped path and a post belt or chain defining a post closed-loop path including a post section extending along the post axis, the vertically-extending lift post being engaged with the post belt or chain in the post section, the actuator belt or chain being driven by the lift post translation actuator, the actuator belt or chain and the post belt or chain being operatively connected to one another through the ratio multiplier assembly, the ratio multiplier assembly comprising an input gear or pulley secured to an output gear or pulley of a larger diameter, the input gear or pulley being engaged in rotation by the actuator belt or chain and the output gear or pulley driving the post belt or chain in rotation, wherein activation of the lift post translation actuator drives the actuator belt or chain and the post belt or chain respectively along the actuator closed-loop path and the post closed-loop path, and the vertically-extending lift post between the raised configuration and the at least one lowered configuration. The actuator belt or chain can comprise a translation actuator section extending along a lift post translation axis and the bathtub frame can comprise a longitudinally extending section. The lift post translation actuator and the transmission assembly can be mounted to the longitudinally extending section of the bathtub frame with the translation actuator section of the actuator belt or chain extending longitudinally along the longitudinally extending section of the bathtub frame and the post section of the post belt or chain extending vertically along the longitudinally extending section of the bathtub frame. The ratio multiplier assembly can have a multiplier ratio of 0.5 to 1. The actuator belt or chain can at least partially surround the input gear or pulley and the post belt or chain can at least partially surround the output gear or pulley.

In an embodiment, the lifting assembly further comprises a seat support assembly extending from an upper section of the vertically-extending lift post.

According to still another general aspect, there is provided a bathtub lift assembly for a bathtub having a bathing cavity. The bathtub lift assembly comprises: a bathtub frame configured to at least partially surround the bathing cavity of the bathtub; a lifting assembly including a vertically-extending lift post mounted to the bathtub frame and a vertical guide assembly, the vertically-extending lift post being translatable along a post axis between a raised configuration and at least one lowered configuration and rotatable about the post axis between a loading configuration and a bathing configuration, the vertical guide assembly including a guiding rail mounted to the bathtub frame and extending substantially parallel to the vertically-extending lift post and a guide translatable with the vertically-extending lift post; and a lift post translation actuator mounted to the bathtub frame and operatively connected to the vertically-extending lift post and activable to translate the vertically-extending lift post between the raised configuration and the at least one lowered configuration; and a lift post rotation actuator mounted to the bathtub frame and activable to rotate the vertically-extending lift post between the bathing configuration and the loading configuration. At least one of the guiding rail and the guide comprises at least a pair thereof at an angularly offset position from one another with respect with the post axis. The pair of the at least one of the guiding rail and the guide is selectively engageable with the other one of the guiding rail and the guide in the loading configuration and the bathing configuration for preventing rotation during the translation of the vertically-extending lift post between the raised configuration and the at least one lowered configuration and being disengageable from one another in the raised configuration to allow rotation of the vertically-extending lift post.

In an embodiment, the lifting assembly can further comprise a post flange mounted to a lower section of the vertically-extending lift post and wherein the pair is a pair of the guide including a bathing configuration guide and a loading configuration guide, the bathing configuration guide and the loading configuration guide being provided on the post flange, the bathing configuration guide being configured to slideably receive the guiding rail for translation in the bathing configuration and the loading configuration guide being configured to slideably receive the guiding rail for translation in the loading configuration. The bathing configuration guide and the loading configuration guide are angularly offset notches defined in the post flange. The lifting assembly further can comprise a post flange mounted to a lower section of the vertically-extending lift post, wherein the guiding rail defines an elongated groove extending substantially parallel to the vertically-extending lift post and the guide comprises a slider protruding from one of the post flange and the vertically-extending lift post, the elongated groove being configured to slideably receive the slider therein. The slider can comprise a bathing configuration slider and a loading configuration slider, the bathing configuration and the loading configuration sliders being angularly offset from one another, the elongated groove selectively receiving the bathing configuration slider for translation of the vertically-extending lift post in the bathing configuration and with the loading configuration slider for translation of the vertically-extending lift post in the loading configuration.

In an embodiment, the lifting assembly further comprises a collar bearing mounted to the bathtub frame and at least partially surrounding at least a section of the vertically-extending lift post to guide the vertically-extending lift post between the raised configuration and the at least one lowered configuration. The collar bearing can be slidably mounted to the bathtub frame and translatable with the vertically-extending lift post between the raised configuration and the at least one lowered configuration. The lifting assembly further can include at least one collar bearing guiding rail and at least one slider secured to the collar bearing and being slideably engaged with the at least one guiding rail to guide the collar bearing and the vertically-extending lift post between the raised configuration and the at least one lowered configuration. The at least one guiding rail can comprise two guiding rails mounted on a respective side of the collar bearing and the at least one slider can comprise two sliders, each one of the two sliders being secured to the collar bearing on a respective side thereof and engaged with a respective one of the two guiding rails.

In an embodiment, the lifting assembly further includes a rotation imparting assembly comprising a first connector mounted to the vertically-extending lift post, and a second connector operatively connected to the lift post rotation actuator, displaceable by the lift post rotation actuator, and engageable with the first connector in the raised configuration of the vertically-extending lift post, wherein when the first connector and the second connector are engaged together, a displacement of the second connector imparts a rotation of the first connector and the vertically-extending lift post about the post axis. The lifting assembly can further comprise a post flange mounted to a lower section of the vertically-extending lift post and the first connector can comprise an aperture defined in the post flange, and the second connector can comprise a pin extending substantially parallel to the vertically-extending lift post and engageable with the aperture defined in the post flange when the vertically-extending lift post is in the raised configuration.

In an embodiment, the lift post translation actuator is a linear actuator and a translation of the linear actuator between an extended configuration and a retracted configuration defines a linear actuator course and a translation of the vertically-extending lift post between the raised configuration and a lowest one of the at least one lowered configuration defines a longest post course, the longest post course being longer than the linear actuator course.

In an embodiment, the vertically-extending lift post comprises a tubular member having a substantially constant diameter from a lower end to an upper end thereof.

In an embodiment, the bathtub lift assembly further comprises a transmission assembly mounted to the bathtub frame and comprising a ratio multiplier assembly and at least two belts or chains including an actuator belt or chain defining an actuator closed-looped path and a post belt or chain defining a post closed-loop path including a post section extending along the post axis, the vertically-extending lift post being engaged with the post belt or chain in the post section, the actuator belt or chain being driven by the lift post translation actuator, the actuator belt or chain and the post belt or chain being operatively connected to one another through the ratio multiplier assembly the ratio multiplier assembly comprising an input gear or pulley secured to an output gear or pulley of a larger diameter, the input gear or pulley being engaged in rotation by the actuator belt or chain and the output gear or pulley driving the post belt or chain in rotation, wherein activation of the lift post translation actuator drives the actuator belt or chain and the post belt or chain respectively along the actuator closed-loop path and the post closed-loop path, and the vertically-extending lift post between the raised configuration and the at least one lowered configuration. The actuator belt or chain can comprise a lift post translation actuator section extending along a lift post translation axis and the bathtub frame can comprise a longitudinally extending section and wherein the lift post translation actuator and the transmission assembly are mounted to the longitudinally extending section of the bathtub frame with the lift post translation actuator section of the actuator belt or chain extending longitudinally along the longitudinally extending section of the bathtub frame and the post section of the post belt or chain extending vertically along the longitudinally extending section of the bathtub frame. The ratio multiplier assembly can have a multiplier ratio of 0.5 to 1. The actuator belt or chain can at least partially surround the input gear or pulley and the post belt or chain can at least partially surround the output gear or pulley.

In an embodiment, the lifting assembly further comprises a seat support assembly extending from an upper section of the vertically-extending lift post, the seat support assembly having a section extending above the bathing cavity in the bathing configuration. The lifting assembly can further comprise a seat mounted to the seat support assembly, the seat extending outwardly of the bathing cavity in the raised configuration of the vertically-extending lift post and in the lowered and loading configuration of the vertically-extending lift post, and inside the bathing cavity in the lowered and bathing configuration of the vertically-extending lift post.

Other features and advantages of the invention will be better understood upon reading of embodiments thereof with reference to the appended drawings.

### BRIEF DESCRIPTION OF THE DRAWINGS

FIG. 1 is a perspective view of a bathtub lift assembly, according to an exemplary embodiment;

FIG. 2 is a side elevation view of the bathtub lift assembly shown in FIG. 1, illustrating a vertically extending lift post in a loading and lowered configuration, according to an exemplary embodiment;

FIG. 3 is a side elevation view of the bathtub lift assembly shown in FIG. 1, illustrating the vertically extending lift post in a raised configuration, according to an exemplary embodiment;

FIG. 4 is a side elevation view of the bathtub lift assembly shown in FIG. 1, illustrating the vertically extending lift post in a lowered and bathing configuration, according to an exemplary embodiment;

FIG. 5 is a front elevation view of the bathtub lift assembly shown in FIG. 1, illustrating the vertically extending lift post in the raised and bathing configuration;

FIG. 6 is a close-up front perspective view of the bathtub lift assembly shown in FIG. 1, illustrating the vertically extending lift post between a lowered configuration and the raised configuration in a loading configuration;

FIG. 7 is a close-up perspective view of the bathtub lift assembly shown in FIG. 1, illustrating the vertically extending lift post in between the lowered configuration and the raised configuration in the bathing configuration;

FIG. 8 is a close-up perspective view of the bathtub lift assembly shown in FIG. 1, illustrating the vertically extending lift post in the raised configuration and bathing configuration;

FIG. 9 is a partial and schematic top view of the bathtub lift assembly shown in FIG. 1, illustrating a seat in the bathing configuration;

FIG. 10 is a partial and schematic top view of the bathtub lift assembly shown in FIG. 1, illustrating the seat in the loading configuration;

FIG. 11 is a close-up perspective view of a lifting assembly of the bathtub lift assembly, in accordance with another embodiment, wherein the lifting assembly includes a portion of a translatable collar bearing configured to surround the vertically extending lift post; and

FIG. 12 is a close-up perspective view of the lifting assembly of the bathtub lift assembly shown in FIG. 11, showing a section of the the vertically extending lift post engaged with the translatable collar bearing.

### DETAILED DESCRIPTION

In the following description, similar features in the drawings have been given similar reference numerals. In order to not unduly encumber the figures, some elements may not be indicated on some figures if they were already mentioned in preceding figures. It should also be understood herein that the elements of the drawings are not necessarily drawn to scale and that the emphasis is instead being placed upon clearly illustrating the elements and structures of the present embodiments.

Moreover, although the embodiments of the bathtub lift assembly for a bathtub consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the bathtub lift assembly, as will be briefly explained herein and as can be easily inferred herefrom by a person skilled in the art. Moreover, it will be appreciated that positional descriptions such as “above”, “below”, “left”, “right”, “front” and “rear” and the like should, unless otherwise indicated, be taken in the context of the figures and should not be considered limiting.

In accordance with embodiments, there is provided a bathtub lift assembly for assisting people with reduced mobility during the transfer from outside of a bathtub to inside of the bathtub and conversely. Some embodiments of the present invention may be particularly useful in a bathtub. Embodiments described hereinbelow permit the fabrication of compact bathtub lift assembly for a bathtub, conjugating stable displacement and constant velocity, as required by the market of such products. In one embodiment, the bathtub lift assembly may be used with a residential bathtub for assisting a person with reduced mobility to safely move from outside the bathtub to inside the bathtub in a stabilized motion. Alternatively, the bathtub lift assembly may be used with pool, hospital bathtub, or the like.

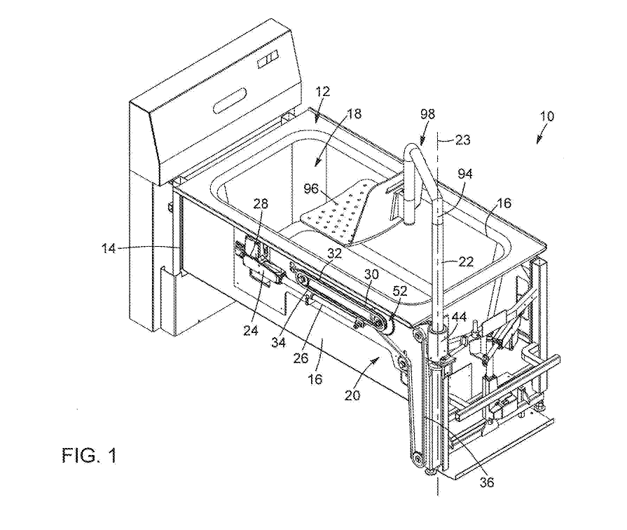

Referring to FIG. 1, an embodiment of a bathtub lift assembly 10 for a bathtub 12 for assisting people with reduced mobility is shown.

The bathtub lift assembly 10 includes a bathtub frame 14 at least partially surrounding the bathtub 12. The bathub 12 can include a tub insert defining a bathing cavity 18 in which a seat 96 of the bathtub lift assembly 10 can be at least partially inserted, as will be described in more details below. Of note, reference to a bathtub 12 herein includes conventional bathtub and other types of tubs, such as a hot tub, a therapeutic tub, or tub-showers.

In the embodiment shown, the bathtub frame 14 includes sidewalls 16, with longitudinally extending sections and transversally extending sections. The sidewalls 16 define a cavity in which a tub insert of the bathtub 12 can be inserted and received.

In an alternative embodiment (not shown), the shape of the bathtub 12 can be defined by the sidewalls 16 of the structural bathtub frame 14 and the cavity 18 can substantially correspond to the cavity defined by the sidewalls 16. Alternatively, as shown in the accompanying figures, the structural bathtub frame 14 can receive and support a tub insert of the bathtub 12.

The bathtub frame 14 also provides mounting points to receive and support to the various components of the bathtub lift assembly 10 which will be described herein below.

The bathtub frame 14 may be outfitted with outer panels (not shown) and materials to give the bathtub 12 a finished look. For example, the bathtub frame 14 may be covered with a plastic or other type of material. Illustratively, the bathtub frame 14 may be formed from steel, but other materials, such as aluminium, plastic, any other materials having the desired properties or a combination thereof may be employed.

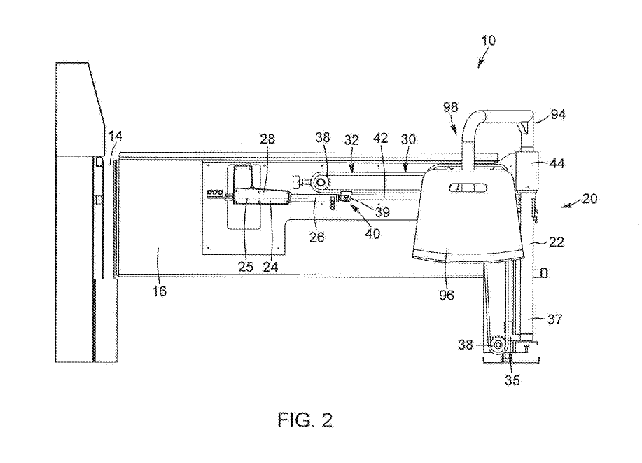

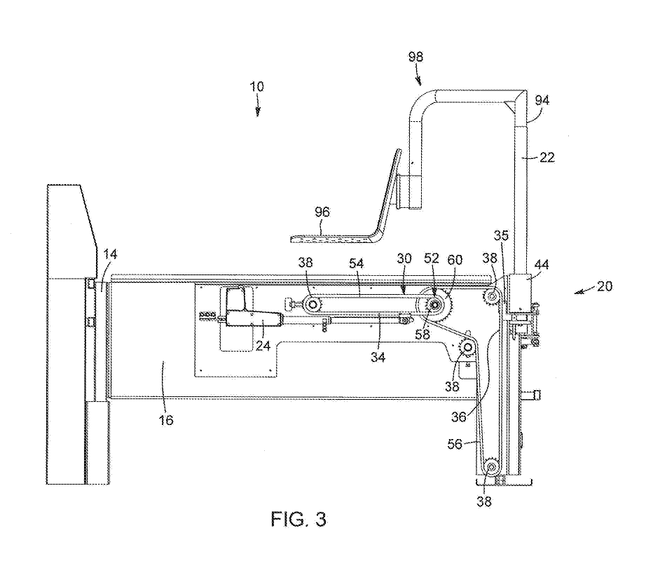

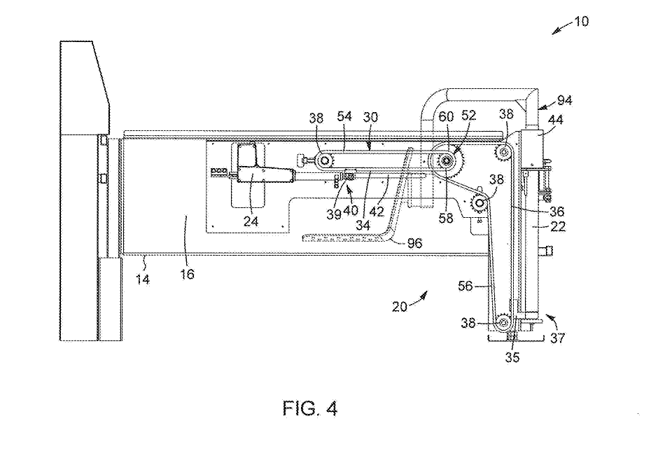

Now referring to FIGS. 1 to 4, the bathtub lift assembly 10 further includes a lifting assembly 20 for displacing the seat between lowered, raised, loading, and bathing configurations, as will be described in more details below. Amongst others, the lifting assembly 20 includes a vertically-extending lift post 22 mounted to the bathtub frame 14 and translatable along a post axis 23 between a raised configuration and at least one lowered configuration. The post axis 23 corresponds to a longitudinal axis of the vertically-extending lift post 22. For example, as illustrated in FIGS. 1 and 3, the vertically-extending lift post 22 is shown in the raised configuration. As illustrated in FIG. 2, the vertically-extending lift post 22 is shown in a one of the lowered configurations and, more particularly, a lowest one of the lowered configurations, i.e. a loading configuration. As illustrated in FIG. 4, the vertically-extending lift post 22 is shown in another one of the at least one lowered configuration which also corresponds to a bathing configuration.

Since a height of the vertically-extending lift post 22 in the loading and the lowest one of the lowered configurations can differ from the height of the vertically-extending lift post 22 in the bathing and the other one of the lowered configurations, the lowered configurations will be referred to as the at least one lowered configuration. It is appreciated that the vertically-extending lift post 22 can be translated from the raised configuration to one, two or more lowered configurations.

Thus, with the respect to its height, the vertically-extending lift post 22 can be selectively configured by translation along the post axis 23 between a raised configuration and at least one lowered configuration. With respect to its angular position, the vertically-extending lift post 22 can be selectively configured between the loading configuration and the bathing configuration. In the bathing configuration (FIG. 1), a seat mounted to the vertically-extending lift post 22 is positioned above the bathing cavity 18 of the bathtub 12, while in the loading configuration (FIG. 2), the seat is positioned beside the bathing cavity 18 of the bathtub 12.

The vertically-extending lift post 22 is thus translatable along the post axis 23 to allow a person to be transported by the lifting assembly 20 from a position exterior and adjacent to the bathtub 12 and the bathing cavity 18 when the vertically-extending lift post 22 is in the loading configuration, and to the bathing configuration where the person is lowered into the bathing cavity 18. As well, a person may be transported by the lifting assembly 20 in a reverse manner, for example from a position within the bathing cavity 18 when the vertically-extending lift post 22 is in the bathing configuration, to the loading configuration where the person is moved exterior to the bathing cavity 18 and adjacent the bathtub 12.

The vertically-extending lift post 22 is illustratively embodied as a cylindrical tube-like structure, which may be hollow or solid for example, and is disposed in a substantially vertical orientation relative to the sidewalls 16. The vertically-extending lift post 22 is illustratively mounted to the bathtub frame 14 at a front side corner of the bathtub 12. Of course, the vertically-extending lift post 22 may be mounted to the bathtub frame 14 at other positions, such as different corners or on an upper section of the sidewalls 16.

In an embodiment, the vertically-extending lift post 22 includes a tubular member which has a substantially constant diameter from a lower end of the vertically-extending lift post to an upper end of the vertically-extending lift post. In an embodiment, the vertically-extending lift post 22 is not a telescopic assembly to provide an increased stability and a substantially constant translation speed.

In the illustrated embodiments of FIGS. 1 to 4, the bathtub lift assembly 10 further includes a lift post translation actuator 24 mounted to the bathtub frame 14 to translate the vertically-extending lift post 22. In the embodiments shown, the actuator 24 is a linear actuator translatable between an extended configuration and a retracted configuration along a linear actuator axis 25. Illustratively, the linear actuator 24 includes a piston 26 which is extendable and retractable from a housing 28 under a form of activation, such as air or a fluid. Other types of actuators 24 may also be provided, such as an electric rod-style actuator, or a rotary actuator. In the illustrated embodiment, the linear actuator axis 25 corresponds to a longitudinal axis of the piston 26. In the embodiment shown, the linear actuator axis 25 extends substantially perpendicular to the post axis 23. In accordance with an embodiment, the linear actuator axis 25 extends along a longitudinally extending one of the sidewalls 16 of the bathtub frame 14, in a substantially horizontal orientation. The lift post translation actuator 24 is shown mounted to a longitudinally-extending one of the sidewalls 16, for example using bolts, screws or the like, and is configured such that the piston 26 is extendable and retractable along a longitudinally-extending section of the bathtub frame 14. Of course, other angles of the linear actuator axis 25 relative to the bathtub frame 14 may also be provided.

In the illustrated embodiments, the bathtub lift assembly 10 further includes a transmission assembly 30 mounted to the bathtub frame 14 and, more particularly, to the longitudinally-extending sidewall 16 including the lift post translation actuator 24 to increase the course of the vertically-extending lift post 22. The transmission assembly 30 includes at least one belt or chain 32 defining a path with an actuator section 34 extending along the linear actuator axis 25 and a post section 36 extending along the post axis 23. The vertically-extending lift post 22 is engaged with the at least one belt or chain 32 in the post section 36 and the lift post translation actuator 24 is engaged with the at least one belt or chain 32 in the actuator section 34. A translation of the lift post translation actuator 24 between the extended configuration and the retracted configuration drives the at least one belt or chain 32 along the path and the vertically-extending lift post 22 between the raised configuration and the at least one lowered configuration.

In the illustrated embodiments of FIGS. 3 and 4, the transmission assembly 30 also includes a ratio multiplier assembly 52. More particularly, the at least one belt or chain 32 includes an actuator belt or chain 54 which defines an actuator closed-loop path and a post belt or chain 56 which defines a post closed-loop path. The actuator belt or chain 54 includes the actuator section 34 and the lift post translation actuator 24 is engaged with the actuator belt or chain 54 in the actuator section 34. The post belt or chain 56 includes the post section 36 extending along the post axis 23. As mentioned above, the vertically-extending lift post 22 is engaged with the post belt or chain 56 in the post section 36. The actuator belt or chain 54 and the post belt or chain 56 are operatively connected to one another through the ratio multiplier assembly 52. In the embodiment shown, the ratio multiplier assembly 52 has an input gear or pulley 58 secured to an output gear or pulley 60 of a larger diameter. The input and output gears or pulleys 58, 60 rotate simultaneously at the same rotation speed. The actuator belt or chain 54 is driven by the lift post translation actuator 24 and partially surrounds the input gear or pulley 58. Thus, the input gear or pulley 58 is engaged in rotation by the actuator belt or chain 54 and the output gear or pulley 60, which is at least partially surrounded by the post belt or chain 56, drives the post belt or chain 56. Upon activation, the lift post translation actuator 24 drives the actuator belt or chain 54 and the post belt or chain 56 respectively along the actuator closed-loop path and the post closed-loop path, and the vertically-extending lift post 22 between the raised configuration and the at least one lowered configuration. As a result of such a configuration, the range of motion of the lift post translation actuator 24 translates into a multiplied range of motion of the vertically-extending lift post 22 as a result of a multiplier ratio of the ratio multiplier assembly 52.

In accordance with an embodiment, the ratio multiplier assembly 52 has a multiplier ratio of 0.5 to 1. Of course, other ratios and configurations of the input gear 58 and the output gear 60 may be provided so as to provide a multiplying effect. It is appreciated that in alternative embodiments, the transmission assembly 30 can include more than one ratio multiplier assembly 52 and more than two belt or chains.

In the illustrated embodiment, the actuator belt or chain 54 and the post belt or chain 56 are wrapped around pulleys 38, 58, 60 so as to define an L-shaped path with the actuator or chain 54 defining a closed-loop path with the actuator section 34, while the post belt or chain 56 defines a closed-looped path with the post section 36 which is illustratively substantially vertical to the bathtub 12 and adjacent to the vertically-extending lift post 22. In the embodiment shown, the post section of the post belt or chain 56 extends substantially along an entire height of the bathtub frame 14, from a lower end to an upper end thereof.

In the embodiment shown and as mentioned above, the actuator belt or chain 54 partially surrounds the input gear or pulley 58 while the post belt or chain 56 partially surrounds the output gear or pulley 60. However, in an alternative embodiment (not shown), the transmission assembly can include more than two belts or chains and two or more ratio multiplier assembly and, thus, the actuator belt or chain 54 and the post belt or chain 56 can be operatively connected through at least one intermediate belt or chain.

In the embodiment shown in the accompanying figures, the at least one belt or chain 32, i.e. the actuator belt or chain 54 and the post belt or chain 56, is shown as a continuous flat belt such as a serpentine belt. It is appreciated that other types of belt may be employed, such as and without being limitative a chain belt, a vee-belt, a chain or the like. Similarly, in the embodiment shown in the accompanying figures, the input and output gears or pulleys 58, 60 are shown as cog wheels but it is appreciated that other types of gears or pulleys can be employed.

A translation of the lift post translation actuator 24 between the extended configuration and the refracted configuration defines a linear actuator course and a translation of the vertically-extending lift post 22 between the raised configuration and a lowest one of the at least one lowered configuration defines a longest post course. With the ratio multiplier assembly 52, the longest post course is longer than the linear actuator course.

Now referring to FIGS. 3 and 4, in the embodiment shown, the post belt or chain 56 in the post section 36 is engaged with the vertically-extending lift post 22 via an L-shaped bracket 35 engaged to a lower section 37 of the vertically-extending lift post 22.

The bathtub lift assembly 10 further includes a bracket assembly 40 to connect a piston tip 39 of the piston 26 to the actuator section 34 of the at least one belt or chain 32 and, more particularly, the actuator belt or chain 54 in the embodiment shown. The bracket assembly 40 is configured to slideably engage with a slot 42 provided in the sidewall 16 to guide the movement of the piston tip 39 along the linear actuator axis 25.

It is appreciated that, in alternative embodiments (not shown), the mechanical connexion between the at least one belt or chain 32 and the vertically-extending lift post 22 and the lift post translation actuator 24 can vary from the embodiments shown.

The above described bathtub lift assembly 10 allows for the vertically-extending lift post 22 to be translatable between the raised configuration and the at least one lowered configuration. The positioning of the lift post translation actuator 24, i.e. to extend along a longitudinal axis of the bathtub frame 14 and normal to the post axis 23, and the connection of the lift post translation actuator 24 to the vertically-extending lift post 22 via the ratio multiplier assembly 52 allows for the vertically-extending lift post 22 to translate over a greater range of motion as compared to a linear actuator provided directly below the vertically-extending lift post 22. The greater range of motion is provided without a telescopic lift post and, thus, an increased stability and a substantially constant speed during displacement can be obtained.

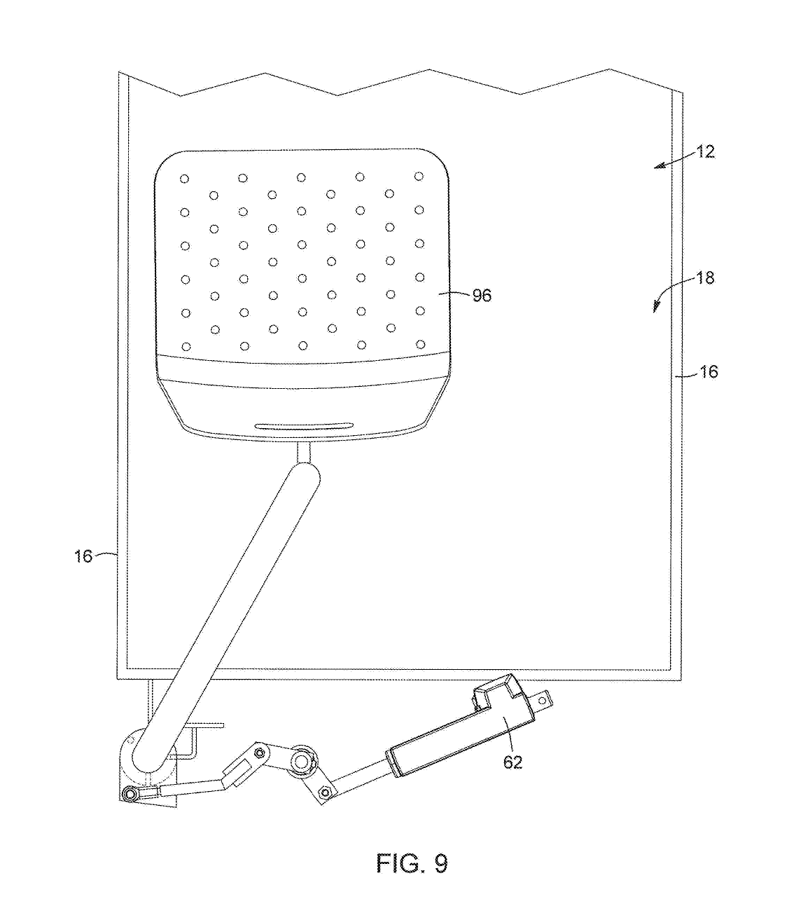

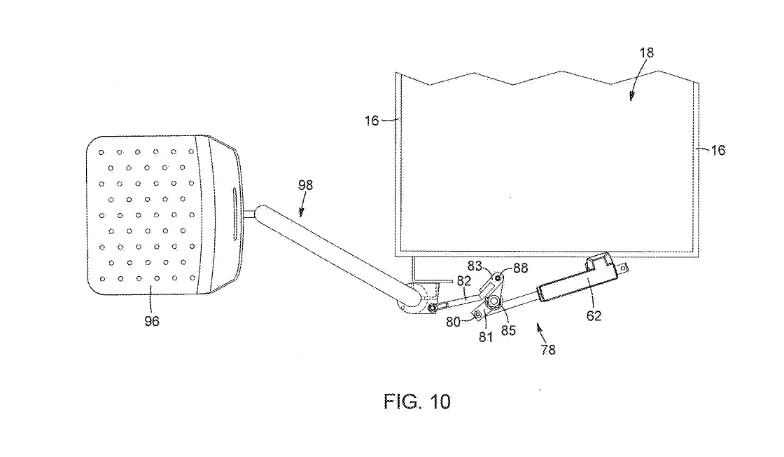

In the embodiment shown in FIGS. 1 to 10, the lifting assembly 20 further includes a collar bearing 44 secured to the bathtub frame 14 and surrounding at least a section of the vertically-extending lift post 22 to guide the vertically-extending lift post 22 between the raised configuration and the at least one lowered configuration. The collar bearing 44 provides support to the vertically-extending lift post 22 as it is translatable along the post axis 23 between the raised configuration and at least one lowered configuration to maintain the vertically-extending lift post 22 in the vertical orientation, while still allowing a rotation of the vertically-extending lift post 22 in a manner which will be discussed herein below. In the embodiment shown, the collar bearing 44 is secured to an upper section of the bathtub frame 14. It is appreciated that it can be secured at any height along the bathtub frame 14 in alternative implementations.

In the embodiment shown, the lifting assembly 20 also includes a post flange 70 mounted to the lower section 37 of the vertically-extending lift post 22 and protruding outwardly from the vertically-extending lift post 22. In the embodiment shown, the post flange 70 has a substantially annular shape but it is appreciated that its shape and configuration can vary from the embodiment shown. According to the illustrated embodiments, the post flange 70 is mounted and secured to a lower end of the vertically-extending post 22, but it is appreciated that the post flange 70 can be mounted to a portion that is nearby the end of the vertically-extending lift post 22. In the embodiment shown, in the raised configuration of the vertically-extending post 22, the post flange 70 almost abuts against a lower surface of the collar bearing 44 in the raised configuration of the vertically-extending post 22.

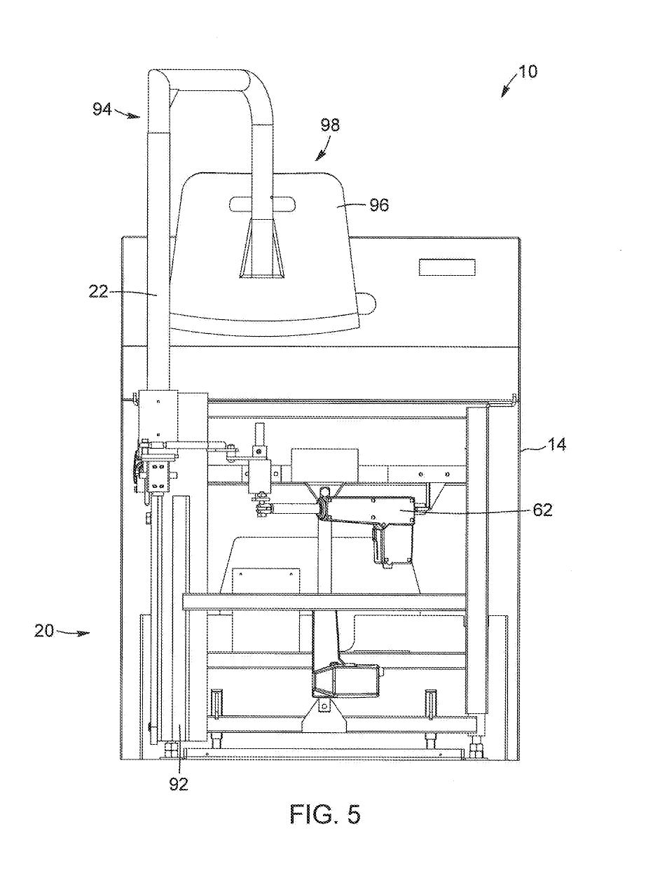

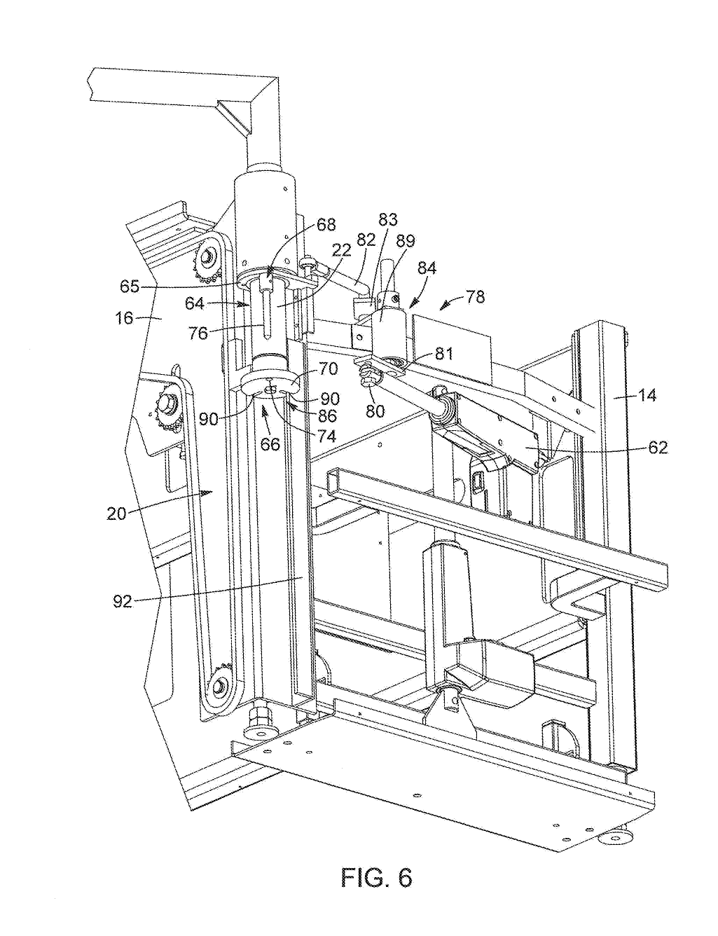

Referring now to FIGS. 5 and 6, in an embodiment, the bathtub lift assembly 10 further includes a lift post rotation actuator 62 mounted to the bathtub frame 14 and activable to rotate the vertically-extending lift post 22 between the bathing configuration and the loading configuration, i.e. to modify its angular position. In an embodiment, the lift post rotation actuator 62 is activable solely in the raised configuration of the vertically-extending lift post 22. In an embodiment, the lift post translation actuator 24 is activable solely in the bathing configuration and the loading configuration, i.e. the lift post translation actuator 24 is not activable in intermediate configuration between the bathing configuration and the loading configuration. As a consequence, the vertically-extending lift post 22 is prevented from rotating about the post axis 23 during translation between the at least one lowered configuration and the raised configuration and the vertically-extending lift post 22 is prevented from translating between the at least one lowered configuration and the raised configuration inbetween the bathing configuration and the loading configuration. Thus, in an embodiment, the lift post rotation actuator 62 and the lift post translation actuator 24 are activable one at a time.

In an embodiment, the lifting assembly 20 also includes a rotation imparting assembly 64 operatively engaged with the vertically-extending lift post 22 to rotate same about the post axis 23. More particularly, in the embodiment shown, the rotation imparting assembly 64 includes a rotation actuator flange 65 at least partially surrounding the vertically-extending lift post 22 and, more particularly, rotatable about the vertically-extending lift post 22. In the embodiment shown, the rotation actuator flange 65 is juxtaposed to a lower surface of the collar bearing 44.

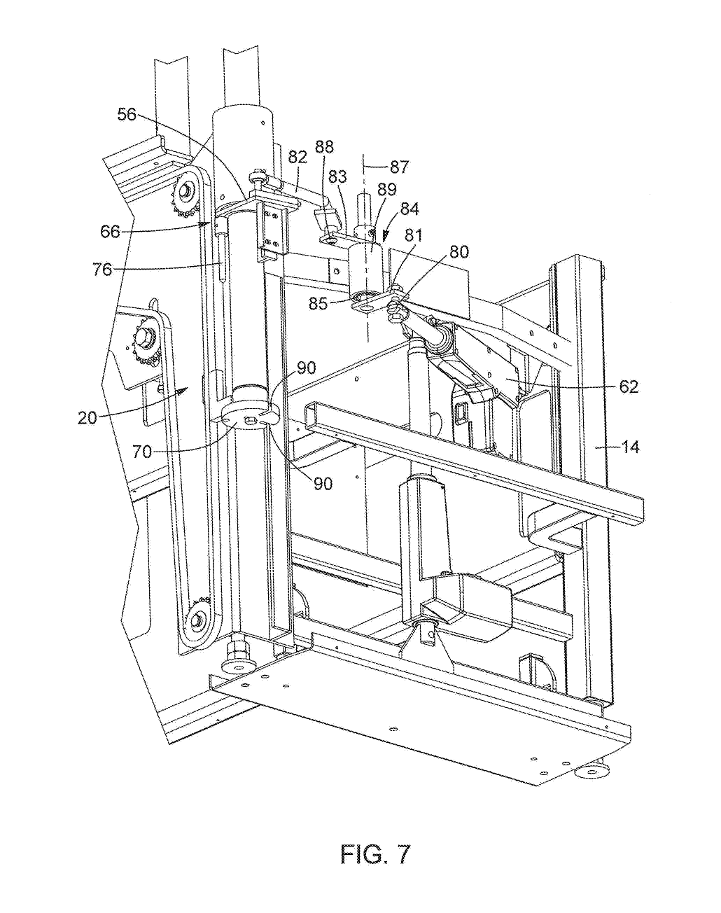

In accordance with an embodiment, the lift post rotation actuator 62 is a linear actuator translatable between an extended configuration and a retracted configuration, and the bathtub lift assembly 10 further includes a push-pull assembly 78 operatively connecting the lift post rotation actuator 62 and the rotation imparting assembly 64. The push-pull assembly 78 includes a swivel assembly 84 engaged with the lift post rotation actuator 62 and a post rod 82 operatively connected with the rotation actuator flange 65 of the rotation imparting assembly 64. The swivel assembly 84 is configured to pull or push the post rod 82 when the lift post rotation actuator 62 is activated. For example, translation of the lift post rotation actuator 62 (i.e. between the retracted configuration to the extended configuration or vice-versa) engages the swivel assembly 84 in rotation, which in turn, pull or push the post rod 82 in accordance with the translation direction of the lift post rotation actuator 62 and the rotation direction of the swivel assembly 84. Displacement of the post rod 82 engages the lift post 22 in rotation between the loading configuration (FIG. 6) and the bathing configuration (FIG. 7), as will be described in more details below. More particularly, in the embodiment shown, translation of the lift post rotation actuator 62 between the extended configuration to the retracted configuration drives the swivel assembly 84 to rotate to push the post rod 82 and rotate the vertically-extending lift post 22, illustratively about the post axis 23, from the loading configuration (FIG. 6) to the bathing configuration (FIG. 7). On the contrary, translation of the lift post rotation actuator 62 between the retracted configuration to the extended configuration drives the swivel assembly 84 to rotate to pull the post rod 82 and rotate the vertically-extending lift post 22, illustratively about the post axis 23, from the bathing configuration (FIG. 7) to the loading configuration (FIG. 6).

In the illustrated embodiments of FIGS. 6 and 7, the swivel assembly 84 is mounted to the bathtub frame 14, in an upper section thereof. More particularly, a swivel assembly casing 89 of the swivel assembly 84 is secured to bathtub frame 14. The post rod 82 extends between the rotation actuator flange 65 surrounding the vertically-extending lift post 22 and the swivel assembly 84 and operatively connect the vertically-extending lift post 22 and the swivel assembly 84 together, as will be described in more details below. The swivel assembly 84 includes a rotatable roller 85 inserted in the swivel assembly casing 89 and rotatable about a roller rotation axis 87, an actuator cam 81 secured to the rotatable roller 85 and engaged with the lift post rotation actuator 62 at an eccentric attachment point 80 with respect to the roller rotation axis 87, and a post cam 83 secured to the rotatable roller 85 and engaged with the post rod 82 at an eccentric attachment point 88 with respect to the roller rotation axis 87. More particularly, a distal end of the lift post rotation actuator 62 is pivotally mounted to the actuator cam 81 at the eccentric attachment point 80 while an end of the post rod 82 is also pivotally mounted to the post cam 83 at the eccentric attachment point 88 Translation of the lift post rotation actuator 62 engages the rotatable roller 85 and the post cam 83 in rotation through the actuator cam 81 and rotation of the post cam 83 displaces the post rod 82. In turn, displacement of the post rod 82 rotates the rotation actuator flange 65 about the post axis 23.

In the embodiment shown, the actuator cam 81 and the post cam 83 are angularly offset and rotate simultaneously with the rotatable roller 85 upon the displacement of the post rod 82. In the embodiment shown and without being limitative, the actuator cam 81 and the post earn 83 have an angular offset of about 180 degrees.

As mentioned above, in the embodiment shown, the rotation actuator flange 65 is rotatable about the lift post 22. This configuration is provided to prevent rotation of the lift post 22 during vertical translation thereof and solely allow rotation when the lift post 22 is in the raised configuration. However, in an alternative embodiment (not shown), it is appreciated that the rotation actuator flange 65 can be secured to the lift post 22 to directly engage the latter in rotation between the loading configuration and the bathing configuration upon rotation thereof.

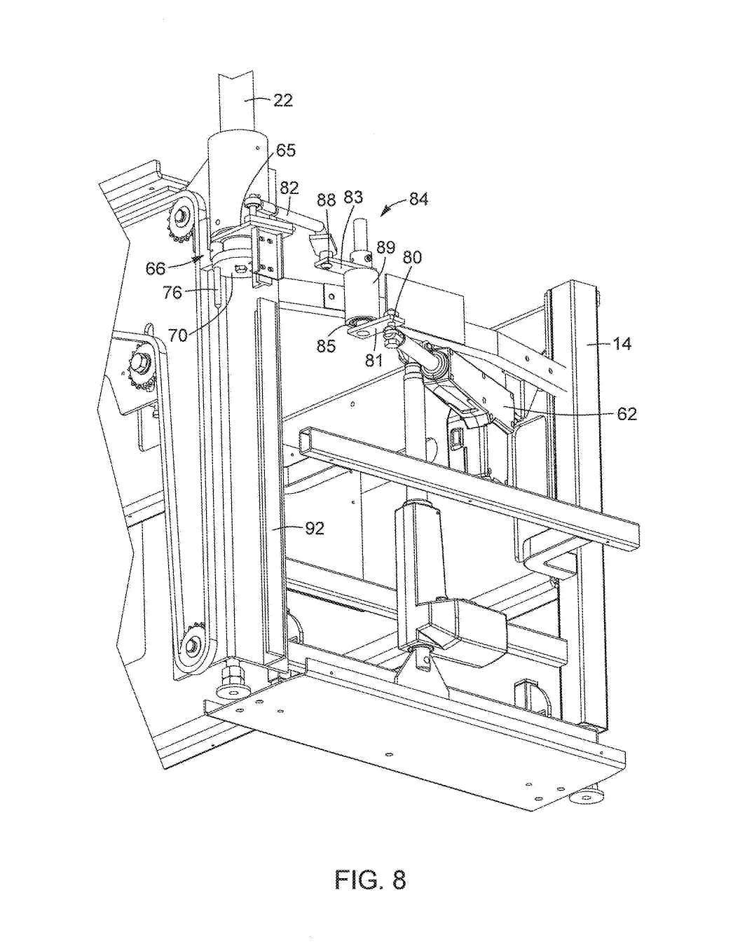

In the embodiment shown, the rotation actuator flange 65 is part of a second connector of the rotation imparting assembly 64. More particularly, in the embodiment shown, the rotation imparting assembly 64 also includes a first connector 66 provided on the vertically-extending lift post 22, and the second connector 68 operatively connected to the lift post rotation actuator 62. More particularly, in the embodiment shown, the first connector 66 includes an aperture 74 defined in the post flange 70 of the lifting assembly 20. The second connector 68 includes the rotation actuator flange 65 surrounding and secured the vertically-extending lift post 22 and a pin 76 extending downwardly from the rotation actuator flange 65, substantially parallel to the vertically-extending lift post 22. The pin 76 is engageable with the aperture 74 defined in the post flange 70 in the raised configuration of the vertically-extending lift post 22, the pin 76 and the aperture 74 being substantially complementary in shape. In other configurations than the raised configuration, the first and second connectors 66, 68 are disengaged. As mentioned above, the vertically-extending lift post 22 is engageable in rotation by the lift post rotation actuator 62 in the raised configuration of the vertically-extending lift post 22, when the first and second connectors are engaged together. Thus, when the first connector 66 and the second connector 68 are engaged as illustrated in FIGS. 5 and 8, a rotation of the second connector 68 (including the rotation actuator flange 65) imparts a rotation of the post flange 70, through the first connector 66, and the vertically-extending lift post 22 to which the post flange 70 is secured. As mentioned above, a change of configuration of the lift post rotation actuator 62 imparts a rotation to the rotation actuator flange 65 and the pin 76 through the swivel 84 assembly and the post rod 82.

FIGS. 6 and 7 show the vertically-extending lift post 22 in a configuration lower than the raised configuration and wherein the first and second connectors 66, 68 are disengaged from one another. Therefore, activation of the lift post rotation actuator 62 does not engage the vertically-extending lift post 22 in rotation about the post axis 23 when the vertically-extending lift post 22 is not configured in the raised configuration.

In accordance with the embodiment shown, the lifting assembly 20 further includes a vertical guide assembly 86 to guide the displacement of the vertically-extending lift post 22 during translation between the at least one lowered configuration and the raised configuration and to prevent rotation during translation. In the embodiment shown, the vertical guide assembly 86 includes a guiding rail 92 extending substantially parallel to the vertically-extending lift post 22, and a guide 90 provided in connection with the vertically-extending lift post 22. The guiding rail 92 and the guide 90 are substantially complementary in shape to be engageable together. In the embodiment shown, the vertical guide assembly 86 includes two guides 90 that are at a radially offset position from one another. The to guides 90 are selectively engageable with the guiding rail 92 in the loading configuration and the bathing configuration for preventing rotation during the translation of the vertically-extending lift post 22 between the raised configuration and the at least one lowered configuration. The two guides 90 are disengaged from the guiding rail 92 in the raised configuration to allow rotation of the vertically-extending lift post 22. Thus, when the first and second connectors 66, 68 of the rotation imparting assembly 64 are engaged together in the raised configuration, the guiding mil(s) 92 and the guide(s) 90 are disengaged from one another. Similarly, when the guiding rail(s) 92 is(are) engaged with respective one(s) of the guide(s) 90 during translation of the vertically-extending lift post 22, the first and second connectors 66, 68 of the rotation imparting assembly 64 are disengaged from one another. Thus, in an embodiment, the guiding rail 92 ends below, or substantially at a same height, than a tip of the pin 76.

It is appreciated that, in an alternative embodiment, the vertical guide assembly 86 can include one or more guides 90.

The two guides 90 being angularly offset, they are selectively engaged with the guiding rail 92 for translation of the vertically-extending lift post 22. A first one of the guides 90 (i.e. a bathing configuration guide) is engaged with the guiding rail 92 for translation in the bathing configuration while a second one of the guides 90 (i.e. a loading configuration guide) is engaged with the guiding rail 92 for translation in the loading configuration. For example, as shown in FIG. 6, one of the two guides 90 is selectively engaged with the guiding rail 92 when the vertically-extending lift post 22 is in the loading configuration for preventing rotation of the vertically-extending lift post 22 during the translation of the vertically-extending lift post 22 between the raised configuration and one lowered configuration. For example, as shown in FIG. 7, the other one of the at least two guides 90 is selectively engaged with the guiding rail 92 when the vertically-extending lift post 22 is in the bathing configuration for preventing rotation of the vertically-extending lift post 22 during the translation of the vertically-extending lift post 22 between the raised configuration and the other one lowered configuration.

In the embodiment shown, the guiding rail 92 is a protruding and elongated track and the guides 90 are notches, i.e. indentations defined in the post flange 70 and, more particularly, a bathing configuration notch and a loading configuration notch. The notches 90 are configured to selectively slideably receive the guiding rail 92 therein. When the notches 90 slideably receive the guiding rail 92, the vertically-extending lift post 22 is prevented from rotating about the post, axis 23. In an embodiment, the shape of the guides 90 is substantially complementary to the shape of the guiding rail 92 and can differ from the embodiment shown.

In an alternative embodiment (not shown), the guide(s) 90 can include slider(s) (not shown) protruding from the vertically-extending lift post 22 or the post flange 70 and the guiding rail 92 can define an elongated groove extending substantially parallel to the vertically-extending lift post 22, wherein the elongated groove is configured to slideably receive the slider(s) therein. In an embodiment, the sliders include a bathing configuration slider engageable with the guiding rail 92 for translation in the bathing configuration and a loading configuration slider engageable with the guiding rail 92 for translation in the loading configuration.

In another alternative embodiment (not shown), the vertical guide assembly 86 can include a guide selectively engageable with two or more guiding rails, each one of the guiding rails corresponding to a respective one of the loading and bathing configurations. Thus, the guide is selectively engageable with a first one of the guiding rails for translation between one of the lowered configurations and the raised configuration in the loading configuration and the guide is selectively engageable with a second one of the guiding rails for translation between one of the lowered configurations and the raised configuration in the bathing configuration.

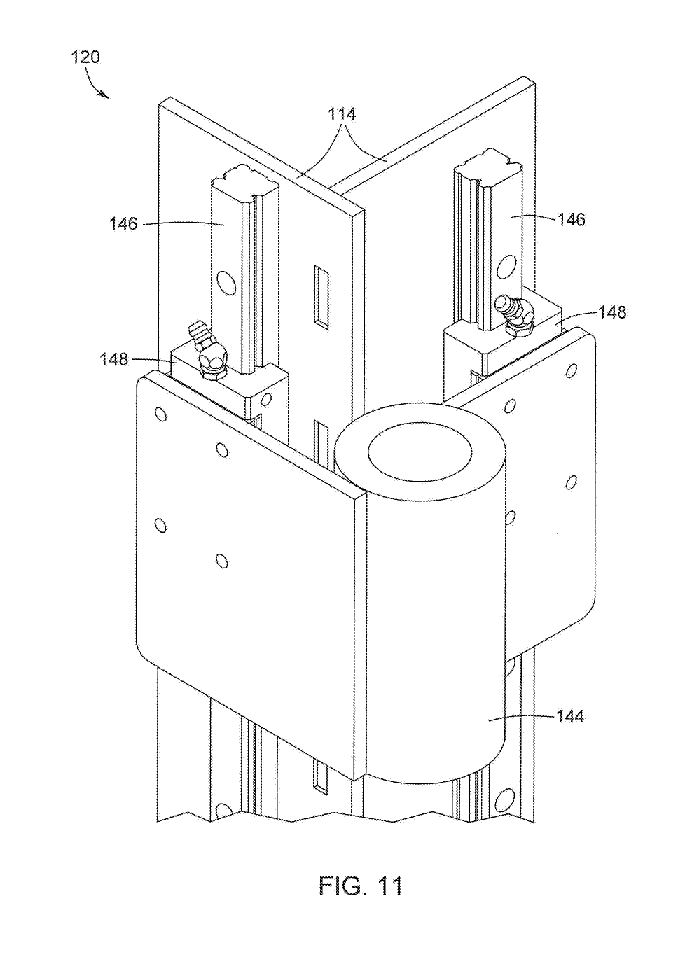

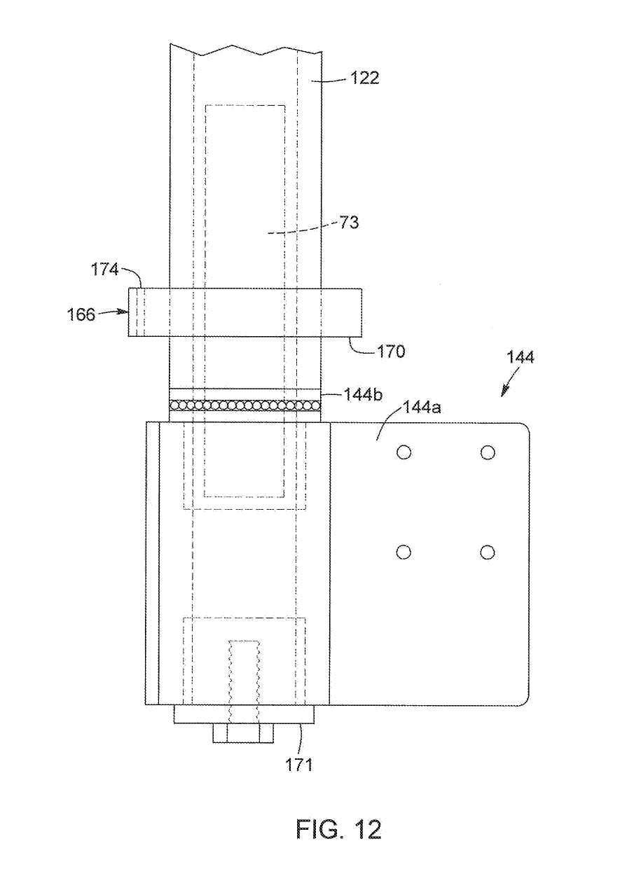

Now referring to FIGS. 11 and 12, an alternative embodiment of a collar bearing 144 for the lifting assembly 120 will be described, wherein the features are numbered with reference numerals in the 100 series which correspond to the reference numerals of the previous embodiment. The collar bearing 144 is slidably mounted to the bathtub frame 114. The vertically-extending lift post 122 is engaged with the translatable collar bearing 144 to translate therewith between the raised configuration and at least one lowered configuration. In the embodiment shown, the collar bearing 144 includes a body 144a with a central aperture and a sleeve bearing 144b abutted against an upper end of the body 144a. The collar bearing 144 also includes a closing flange 171 and a connecting stem 173 provided at opposed ends of the body 144a. The closing flange 171 is mounted to the body 144a and closes the central aperture thereof at a lower end thereof. The connecting stem 173 has an end secured to the collar bearing 144, in an upper section thereof, and protrudes from the collar bearing 144. The upper section of the connecting stem 173 is inserted in an aperture defined in a lower section of the vertically-extending lift post 122. The lower end of the vertically-extending lift post 122 abuts against the sleeve bearing 144b, i.e. the sleeve bearing 144b extends between the body 144a and the vertically-extending lift post 122. Thus, the vertically-extending lift post 122 is rotatable about the body 144a of the collar bearing 144. It is appreciated that the engagement between the collar bearing 144 and the vertically-extending lift post 122 can differ from the embodiment shown provided that the vertically-extending lift post 122 is rotatable with respect to the collar bearing 144 and translatable by the collar bearing 144.

In the embodiment shown, the lifting assembly 120 includes two collar bearing guiding rails 146 mounted to the bathtub frame 114 and extending substantially parallel to the vertically-extending lift post 122, and two sliders 148 secured to the collar bearing 144 and translating therewith. More particularly, each one of the sliders 148 is secured to the collar bearing 144, on a respective side thereof. A first one of the collar bearing guiding rails 146 is mounted to one of the longitudinally extending sidewalls and a second one of the collar bearing guiding rails 146 is mounted to one of the transversally extending sidewalls (or bathtub frame sections). Each one of the sliders 148 is slideably engageable with a respective one of the collar bearing guiding rails 146 to guide the assembly including the vertically-extending lift post 122 and the collar bearing 144 between the raised configuration and the at least one lowered configuration.

Even though in the illustrated embodiment of FIG. 11, two collar bearing guiding rails 146 and two corresponding sliders 148 are shown, it is appreciated that the lifting assembly 120 can include one or more collar bearing guiding rail 146 and slider 148.

As the embodiment shown in FIGS. 1 to 10, the embodiment shown in FIGS. 11 and 12 also includes a rotation imparting assembly 164. The rotation imparting assembly 164 includes a first connector 166 embodied by an aperture 174 defines in a post flange 170. The post flange 170 is provided above the collar bearing 144 and is secured to the vertically-extending lift post 122 and translates vertically therewith between the at least one lowered configuration and the raised configuration. The rotation imparting assembly 164 also includes a second connector (not shown) including a rotation actuator flange and a pin (not shown) protruding from the rotation actuator flange. The rotation imparting assembly 164 is provided close to an upper end of the bathtub frame and is not shown in FIGS. 11 and 12 but is similar to the one described in reference to FIGS. 1 to 10. The rotation actuator flange is rotatable about the vertically-extending lift post 122 and is operatively connected the lift post rotation actuator. For instance and without being limitative, the rotation actuator flange can be operatively connected the lift post rotation actuator through the assembly including the swivel assembly described above in reference to FIGS. 1 to 10. Thus, activation of the lift post rotation actuator engages the rotation actuator flange is rotation about the post axis. As the pin 76, the pin of the second connector is engageable with the aperture 174 defined in the post flange 170 in the raised configuration of the vertically-extending lift post 122. Thus, in the raised configuration, the vertically-extending lift post 122 is engageable in rotation by the lift post rotation actuator 62 throught the engagement of the first and second connectors.

The lifting assemblies 20, 120 can further include a seat support assembly 98 extending from an upper section 94 of the vertically-extending lift post 22, 122, the seat support assembly 98 has a section extending above the bathing cavity 18 in the bathing configuration as illustrated in FIG. 4.

In an embodiment, the lifting assemblies 20, 120 can further include a seat 96 mounted to the seat support assembly 98, the seat 96 extending outwardly of the bathing cavity 18 in the raised configuration of the vertically-extending lift post 22, 122 and in the lowered and loading configurations of the vertically-extending lift post 22, 122, and inside the bathing cavity 18 in the lowered and bathing configurations of the vertically-extending lift post 22, 122. As a result, a person of reduced physical mobility may be seated on the seat 96 when the vertically-extending lift post 22, 122 is in the loading and lowered configuration and be moved by the translation of the vertically-extending lift post 22, 122 to the bathing configuration where the seat 96, and the person are positioned within the bathing cavity 18.

In an embodiment, the actuators 24, 62, the ratio multiplier assembly 52, the rotation imparting assembly 64, the swivel assembly 84 can be covered by panels and hidden from the patient and the user, i.e. enclosed in the bathtub frame 14.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A bathtub lift assembly for a bathtub having a bathing cavity, the bathtub lift assembly comprising:
a bathtub frame configured to at least partially surround the bathing cavity of the bathtub;
a lifting assembly comprising a vertically-extending lift post mounted to the bathtub frame and translatable along a post axis between a raised configuration and at least one lowered configuration;
a linear actuator mounted to the bathtub frame and translatable between an extended configuration and a retracted configuration along a linear actuator axis; and
a transmission assembly mounted to the bathtub frame and comprising at least one belt or chain defining a closed-loop path with an actuator section extending along the linear actuator axis and a post section extending along the post axis, the vertically-extending lift post being engaged with the at least one belt or chain in the post section and the linear actuator being engaged with the at least one belt or chain in the actuator section, wherein translation of the linear actuator between the extended configuration and the retracted configuration drives the at least one belt or chain along the closed-loop path and the vertically-extending lift post between the raised configuration and the at least one lowered configuration.

2. The bathtub lift assembly of claim 1, wherein the bathtub frame comprises a longitudinally extending section and the linear actuator and the transmission assembly are mounted to the longitudinally extending section of the bathtub frame with the actuator section of the closed-loop path extending longitudinally along the longitudinally extending section of the bathtub frame and the post section of the closed loop path extending vertically along the longitudinally extending section of the bathtub frame.

3. The bathtub lift assembly of claim 1, wherein the vertically-extending lift post comprises a tubular member having a substantially constant diameter from a lower end to an upper end thereof and the lifting assembly further comprises a seat support assembly extending from an upper section of the vertically-extending lift post.

4. The bathtub lift assembly of claim 1, wherein a translation of the linear actuator between the extended configuration and the retracted configuration defines a linear actuator course and a translation of the vertically-extending lift post between the raised configuration and a lowest one of the at least one lowered configuration defines a longest post course, the longest post course being longer than the linear actuator course.

5. The bathtub lift assembly of claim 1, wherein the transmission assembly comprises a ratio multiplier assembly and the at least one belt or chain comprises a that belt or chain defining a first closed-loop path and a second belt or chain defining a second closed-loop path, the first belt or chain and the second belt or chain being engaged with the ratio multiplier assembly, the first belt or chain being driven in rotation around the first closed-loop path by the linear actuator, the second belt of chain being engaged in rotation around the second closed-loop path through the ratio multiplier assembly and engaging the vertically-extending lift post in translation.

6. The bathtub lift assembly of claim 1, wherein the lifting assembly further comprises a vertical guide assembly including a guiding rail mounted to the bathtub frame and extending substantially parallel to the vertically-extending lift post and a guide translatable with the vertically-extending lift post, the guiding rail and the guide being engageable together for preventing rotation of the vertically-extending lift post during the translation thereof and being disengageable from one another in the raised configuration to allow rotation of the vertically-extending lift post.

7. A bathtub lift assembly for a bathtub having a bathing cavity, the bathtub lift assembly comprising:
a bathtub frame configured to at least partially surround the bathing cavity of the bathtub:
a lifting assembly including a vertically-extending lift post mounted to the bathtub frame and translatable along a post axis between a raised configuration and at least one lowered configuration;
a lift post translation actuator mounted to the bathtub frame; and
a transmission assembly mounted to the bathtub frame and comprising a ratio multiplier assembly and at least two belts or chains including an actuator belt or chain defining an actuator closed-loop path and a post belt or chain defining a post closed-loop path including a post section extending along the post axis, the vertically-extending lift post being engaged with the post belt or chain in the post section, the actuator belt or chain being driven by the lift post translation actuator, the actuator belt or chain and the post belt or chain being operatively connected to one another through the ratio multiplier assembly the ratio multiplier assembly comprising an input gear or pulley secured to an output gear or pulley of a larger diameter, the input gear or pulley being engaged in rotation by the actuator belt or chain and the output gear or pulley driving the post belt or chain in rotation, wherein activation of the lift post translation actuator drives the actuator belt or chain and the post belt or chain respectively along the actuator closed-loop path and the post closed-loop path, and the vertically-extending lift post between the raised configuration and the at least one lowered configuration.

8. The bathtub lift assembly of claim 7, wherein the actuator belt or chain comprises a translation actuator section extending along an actuator axis, the lift post translation actuator being a linear actuator engaged with the actuator belt or chain in the translation actuator section, wherein the bathtub frame comprises a longitudinally extending section, the vertically-extending lift post comprises a tubular member having a substantially constant diameter from a lower end to an upper end thereof, and the lifting assembly further comprises a collar bearing mounted to the bathtub frame and at least partially surrounding at least a section of the vertically-extending lift post to guide the vertically-extending lift post between the raised configuration and the at least one lowered configuration; and wherein the lift post translation actuator and the transmission assembly are mounted to the longitudinally extending section of the bathtub frame with the translation actuator section of the actuator belt or chain extending longitudinally along the longitudinally extending section of the bathtub frame and the post section of the post belt or chain extending vertically along the longitudinally extending section of the bathtub frame, and wherein a translation of the linear actuator between an extended configuration and a retracted configuration defines a linear actuator course and a translation of the vertically-extending lift post between the raised configuration and a lowest one of the at least one lowered configuration defines a longest post course, the longest post course being longer than the linear actuator course.

9. The bathtub lift assembly of claim 7, wherein the lifting assembly further comprises a vertical guide assembly including a guiding rail mounted to the bathtub frame and extending substantially parallel to the vertically-extending lift post and a guide translatable with the vertically-extending lift post, the guiding rail and the guide being engageable together for preventing rotation of the vertically-extending lift post during a translation thereof and being disengageable from one another in the raised configuration to allow rotation of the vertically-extending lift post.

10. A bathtub lift assembly for a bathtub having a bathing cavity, the bathtub lift assembly comprising:
a bathtub frame configured to at least partially surround the bathing cavity of the bathtub;
a lifting assembly including a vertically-extending lift post mounted to the bathtub frame and translatable, along a post axis between a raised configuration and at least one lowered configuration and rotatable about the post axis between a loading configuration and a bathing configuration;
a lift post translation actuator mounted to the bathtub frame and operatively connected to the vertically-extending lift post and activable to translate the vertically-extending lift post between the raised configuration and the at least one lowered configuration;
a lift post rotation actuator, translatable between an extended configuration and a retracted configuration, the lift post rotation actuator being mounted to the bathtub frame and activable to rotate the vertically-extending lift post between the bathing configuration and the loading configuration, wherein the lift post rotation actuator and the lift post translation actuator are activable one at a time; and
a push-pull assembly comprising a swivel assembly mounted to the bathtub frame and a post rod operatively connecting the vertically-extending lift post and to the swivel assembly, the swivel assembly including a rotatable roller rotatable about a roller rotation axis, an actuator cam secured to the rotatable roller and engaged with the lift post rotation actuator at an eccentric attachment point with respect to the roller rotation axis, and a post cam secured to the rotatable roller and engaged with the post rod at an eccentric attachment point with respect to the roller rotation axis, wherein translation of the lift post rotation actuator engages the rotatable roller and the post cam in rotation through the actuator cam and rotation of the post cam displaces the post rod, and displacement of the post rod rotates the lift post between the loading configuration and the bathing configuration, when the vertically-extending lift post is configured in the raised configuration.

11. The bathtub lift assembly of claim 10, wherein the actuator cam and the post can rotate simultaneously with the rotatable roller and are angularly offset.

12. The bathtub lift assembly of claim 10, wherein the lifting assembly further includes a rotation imparting assembly comprising a first connector mounted to the vertically-extending lift post and a second connector operatively connected to the lift post rotation actuator, displaceable by a change of configuration of the lift post rotation actuator, and engageable with the first connector in the raised configuration of the vertically-extending lift post, wherein, when the first connector and the second connector are engaged together, a displacement of the second connector imparts a rotation of the first connector and the vertically-extending lift post about the post axis.

13. The bathtub lift assembly of claim 12, wherein the lifting assembly further comprises a post flange mounted to a lower section of the vertically-extending lift post; the first connector comprises an aperture defined in the post flange, and the second connector comprises a pin extending substantially parallel to the vertically-extending lift post, rotatable about the post axis, and engageable with the aperture defined in the flange when the vertically-extending lift post is in the raised configuration; and wherein the second connector comprises a rotation actuator flange at least partially surrounding the post axis and being rotatable thereabout, the pin protruding from the rotation actuator flange, the second connector being operatively connected to the swivel assembly via the post rod wherein a change of configuration of the lift post rotation actuator imparts a rotation to the rotation actuator flange and the pin about the post axis through the swivel assembly and the post rod.

14. The bathtub lift assembly of claim 13, wherein the lifting assembly further comprises a vertical guide assembly including a guiding rail mounted to the bathtub frame and extending substantially parallel to the vertically-extending lift post and the post flange comprises a bathing configuration notch and a loading configuration notch, the bathing configuration and the loading configuration notches being angularly offset from one another, the guiding rail being selectively engaged with the bathing configuration notch for translating of the vertically-extending lift post in the bathing configuration and with the loading configuration notch for translating of the vertically-extending lift post in the loading configuration.

15. The bathtub lift assembly of claim 10, wherein the vertically-extending lift post comprises a tubular member having a substantially constant diameter from a lower end to an upper end thereof and the lifting assembly further comprises a collar bearing mounted to the bathtub frame and at least partially surrounding at least a section of the vertically-extending lift post to guide the vertically-extending lift post between the raised configuration and the at least one lowered configuration.

16. The bathtub lift assembly of claim 10, wherein the bathtub lift assembly further comprises a transmission assembly mounted to the bathtub frame and comprising a ratio multiplier assembly having a multiplier ratio of 0.5 to 1 and at least two belts or chains including an actuator belt or chain defining an actuator closed-looped path and a post belt or chain defining a post closed-loop path including a post section extending along the post axis, the vertically-extending lift post being engaged with the post belt or chain in the post section, the actuator belt or chain being driven by the lift post translation actuator, the actuator belt or chain and the post belt or chain being operatively connected to one another through the ratio multiplier assembly, the ratio multiplier assembly comprising an input gear or pulley secured to an output gear or pulley of a larger diameter, the input gear or pulley being engaged in rotation by the actuator belt or chain and the output gear or pulley driving the post belt or chain in rotation, wherein activation of the lift post translation actuator drives the actuator belt or chain and the post belt or chain respectively along the actuator closed-loop path and the post closed-loop path, and the vertically-extending lift post between the raised configuration and the at least one lowered configuration.

17. A bathtub lift assembly for a bathtub having a bathing cavity, the bathtub lift assembly comprising:
a bathtub frame configured to at least partially surround the bathing cavity of the bathtub;
a lifting assembly including a vertically-extending lift post mounted to the bathtub frame and a vertical guide assembly, the vertically-extending lift post being translatable along a post axis between a raised configuration and at least one lowered configuration and rotatable about the post axis between a loading configuration and a bathing configuration, the vertical guide assembly including a guiding rail mounted to the bathtub frame and extending substantially parallel to the vertically-extending lift post and a guide translatable with the vertically-extending lift post; and
a lift post translation actuator mounted to the bathtub frame and operatively connected to the vertically-extending lift post and activable to translate the vertically-extending lift post between the raised configuration and the at least one lowered configuration;
a lift post rotation actuator mounted to the bathtub frame and activable to rotate the vertically-extending lift post between the bathing configuration and the loading configuration;
wherein, at least one of the guiding rail and the guide comprises at least a pair thereof at an angularly offset position from one another with respect with the post axis, the pair of the at least one of the guiding rail and the guide being selectively engageable with the other one of the guiding rail and the guide in the loading configuration and the bathing configuration for preventing rotation during the translation of the vertically-extending lift post between the raised configuration and the at least one lowered configuration and being disengageable from one another m the raised configuration to allow rotation of the vertically-extending lift post.

18. The bathtub lift assembly of claim 17, wherein the lifting assembly further comprises a post flange mounted to a lower section of the vertically-extending lift post and wherein the pair is a pair of the guide including a bathing configuration guide and a loading configuration guide, the bathing configuration guide and the loading configuration guide being provided on the post flange, the bathing configuration guide being configured to slideably receive the guiding rail for translation in the bathing configuration and the loading configuration guide being configured to slideably receive the guiding rail for translation in the loading configuration.

19. The bathtub lift assembly of claim 18, wherein the bathing configuration guide and the loading configuration guide are angularly offset notches defined in the post flange.

20. The bathtub lift assembly of claim 17, wherein the lifting assembly further comprises a collar bearing mounted to the bathtub frame and at least partially surrounding at least a section of the vertically-extending lift post to guide the vertically-extending lift post between the raised configuration and the at least one lowered configuration.

21. The bathtub lift assembly of claim 20, wherein the collar bearing is slidably mounted to the bathtub frame and translatable with the vertically-extending lift post between the raised configuration and the at least one lowered configuration and the lifting assembly further comprises at least one collar bearing guiding rail and at least one slider secured to the collar bearing and being slideably engaged with the at least one guiding rail to guide the collar bearing and the vertically-extending lift post between the raised configuration and the at least one lowered configuration.

22. The bathtub lift assembly of claim 17, wherein the lifting assembly further comprises a post flange mounted to a lower section of the vertically-extending lift post and a rotation imparting assembly, the rotation imparting assembly comprising a first connector comprising an aperture defined in the post flange and a second connector operatively connected to the lift post rotation actuator and displaceable by the lift post rotation actuator, the second connector comprising a pin extending substantially parallel to the vertically-extending lift post and engageable with the aperture defined in the post flange when the vertically-extending lift post is in the raised configuration, wherein when the first connector and the second connector are engaged together, a displacement of the second connector imparts a rotation of the first connector and the vertically-extending lift post about the post axis.

23. The bathtub lift assembly of claim 17, wherein the lifting assembly further comprises a seat support assembly and a seat, the seat support assembly extending from an upper section of the vertically-extending lift post, the seat support assembly having a section extending above the bathing cavity in the bathing configuration; the seat being mounted to the seat support assembly and extending outwardly of the bathing cavity in the raised configuration of the vertically-extending lift post and in the lowered and loading configuration of the vertically-extending lift post, and inside the bathing cavity in the lowered and bathing configuration of the vertically-extending lift post.
